(19) United States
(12) Patent Application Publication
(10) Pub. No.: US 2016/0148542 A1
(43) Pub. Date: May 26, 2016

(54) DEVICE AND METHOD FOR SIMULATING PULMONARY ENVIRONMENTS

(71) Applicant: LIVERPOOL JOHN MOORES UNIVERSITY, Liverpool, Merseyside (GB)

(72) Inventor: Michael James DAVIES, Liverpool (GB)

(21) Appl. No.: 14/897,766

(22) PCT Filed: Jun. 13, 2014
(86) PCT No.: PCT/GB2014/051835

§ 371 Date: Dec. 11, 2015

(30) Foreign Application Priority Data
Jun. 13, 2013 (GB) 1310502.8

(51) Int. Cl. G09B 23/30

(52) U.S. Cl. CPC G09B 23/303

(57) ABSTRACT

In one aspect, the present invention relates to a device for simulating and studying the absorption of a sample in a pulmonary environment. In some embodiments, the device comprises (a) a surfactant monolayer located within a barrier, wherein at least part of the barrier is movable so as to enable a force to be applied to the monolayer; (b) a reservoir of liquid disposed underneath the monolayer; (c) a dispenser for dispensing a sample on to the monolayer; and (d) a circulation arrangement adapted to circulate the liquid in the reservoir underneath the monolayer.

### TECHNICAL FIELD OF THE INVENTION

The invention relates to devices for simulating pulmonary environments for improved testing of the behaviour of various molecules and particles in a lung environment.

### BACKGROUND OF THE INVENTION

Drug delivery via the lung presents an excellent route to treat a wide range of local and systemic disease states and has attracted significant attention within recent years. The appeal of this mode of drug delivery may be ascribed to several factors, including for example the large surface area conferred by the lung and the evasion of hepatic first pass metabolism. Consequently, great interest has been stimulated in developing a range of formulations specifically for pulmonary drug delivery, these include for instance engineered particles, nano-sized particles and sustained release particles. Although a drive does exist to develop such particulate material in an attempt to optimise treatment outcomes, it appears that to date relatively little consideration has been given to accurately testing the efficacy and dissolution of these (and indeed existing pharmaceutically active) particles by the lungs. Furthermore, the nature of interaction between inhaled drug particles and pulmonary fluid (i.e. pulmonary surfactant and the related hypophase) is largely unknown, despite the fluid being both the initial point of contact for a drug particle upon delivery to the deep lung and the media in which dissolution takes place.

Drug developers require insights into their ability to control the dissolution rate of respirable drug-containing formulations. Currently however there are no regulatory requirements or established pharmacopoeial tests for the dissolution testing of Orally Inhaled Products (OIPs). This is due to the lack of validated commercially available testing services and products.

It is an object of the present invention to address one or more of problems highlighted above. In particular, an object is to provide a device and/or methods which replicate or provide an improved simulated pulmonary environment. Such a pulmonary environment would preferably include a more accurate air/liquid barrier model. The pulmonary environment of the invention would preferably be suited to a number of tasks, such as investigating particle dissolution profiles and development of new particulate materials so as to improve understanding of drug release mechanisms and thereby inform formulation practice.

### SUMMARY OF THE INVENTION

In accordance with a first aspect of the present invention, there is provided a device for simulating and studying the absorption of a sample in a pulmonary environment comprising:

(a) a surfactant monolayer located within a barrier, wherein at least part of the barrier is movable so as to enable a force to be applied to the monolayer;

(b) a reservoir of liquid disposed underneath the monolayer;

(c) a dispenser for dispensing the sample on to the monolayer; and

(d) a circulation arrangement adapted to circulate the liquid in the reservoir underneath the monolayer.

The device may further comprise:

(e) an analytical arrangement capable of analysing the liquid.

The analytical arrangement may be utilised for assessing the absorption of a range of samples (or components thereof) in the liquid. For example, the sample may comprise a pharmaceutically active ingredient which may be in the form of a fine powder or aerosol. The sample may comprise particulate material. alternatively or additionally, the sample may comprise an environmental gaseous sample, such as cigarette smoke or vapours. It will be apparent that the device of the invention (and related method) will allow for a more accurate model in which to mimic the lung lining and assess how effective (and the rates at which) certain molecules are absorbed in the lungs. This can not only assist in directing pharmaceutical formulation but also provide an understanding of the effect of certain environmental conditions upon an individual.

The dispenser may take whatever form best suits the delivery of the sample. For example, aerosols may be dispensed from an atomiser, smoke and vapours may be dispensed from a conduit and powder may be dispensed from a vibrating mesh nozzle. At least part of barrier may be movable along a lateral axis so as to provide a lateral force on the monolayer. The barrier may take the form of a number of configurations, but will preferably be a rectangular shape with two of the four sides being movable so as to reduce and increase the upper surface area and therefore capable of applying a cyclical reciprocating force to the monolayer.

The circulation arrangement may be adapted to circulate the liquid continuously and/or cyclically whilst substantially maintaining the same volume of liquid in the reservoir. In this way, the device better simulates the pulmonary environment and in particular breathing and how this affects the mucosal membrane and the air/liquid barrier. In some instances, the circulation arrangement may allow for the removal of a very small quantity of liquid (for example 0.2 ml) for testing—however, it is envisaged that such removal would only have a negligible effect the overall volume of liquid in the reservoir. In other instances, the circulation arrangement may allow for the removal of a quantity of liquid for testing and a substantially similar quantity of fresh media be replenished so as to ensure that the volume of the liquid remains constant and the dissolution/dispersion profile of the liquid mimics the lung environment and supersaturation by the sample is prevented. The different circulation arrangements can also be adapted to mimic a single dose or continuous dose regimes and also to enable the device to easily be adapted for first or zero order kinetics analysis.

An overflow can also be provide in the device so as to allow excess liquid to be expelled from the device should the volume under the monolayer exceed the desired or allowable volume.

A humidity probe may be provided near to the upper surface of the monolayer so as to assess the humidity level near to the monolayer. If the probe detects that the humidity is not at the desired level then it can be adjusted accordingly.

An electrostatic eliminator device may also be provided to reduce electrical charge effects on molecules and particles being tested.

The analytical arrangement will preferably be capable of analysing the liquid passing through the circulation arrangement and/or under the monolayer. Many analytical arrangements may be applied in conjunction with this device and most will be adapted to the more specific experiments being conducted. For example, particle dissolution could be assessed by means of UV spectrophotometer, whereas concentration of a dissolved pharmaceutical composition could be assessed by means of HPLC analysis. More than one analytical method may be employed for the same test, for example the particle dissolution and hence drug concentration within the fluid could be tested by UV or HPLC approaches. Two or more analytical methods may be employed, for example testing a sample through the HPLC and use UV (along with other analytical tools) to assess a concentration value with respect to time.

In accordance with a further aspect of the present invention, there is provided a method of simulating and studying the absorption of a sample in a pulmonary environment comprising:

(a) providing a reservoir of liquid overlaid with a surfactant monolayer;

(b) applying a cyclical lateral force to the monolayer;

(c) circulating the liquid in the reservoir underneath the monolayer;

(d) contacting the sample with the monolayer; and

(e) analysing the liquid for presence and/or quantity of the sample, or component thereof, in the liquid after a pre-determined incubation time.

The liquid may circulate continuously or cyclically whilst substantially maintaining the same volume of liquid in the reservoir.

In accordance with yet a further aspect of the present invention, there is provided a device for analysing dissolution and/or distribution of particles in a pulmonary environment comprising:

(a) a particulate material dispenser;

(b) a surfactant monolayer overlaying a reservoir of liquid;

(c) a circulation arrangement adapted to circulate the liquid in the reservoir; and

(d) an analytical arrangement capable of analysing the liquid

wherein the particle dispenser is located adjacent to the monolayer so as to enable particulate material to be dispensed onto the monolayer and the analytical arrangement allows the distribution and/or dissolution of the particulate material within and throughout the liquid to be assessed continuously and/or periodically.

The device may further comprise a barrier around the monolayer which can apply a pre-determined lateral force to the monolayer. Preferably, at least part of the barrier is reciprocally movable along a lateral axis. The circulation arrangement may be adapted to circulate the liquid continuously and/or cyclically whilst substantially maintaining the same volume of liquid in the reservoir. The device may further comprise an enclosure for enclosing the dispenser and monolayer and may include a humidifier for producing and controlling the humidity within the enclosure.

The particulate material dispenser may comprise a loading area for loading and storing particulate material for analysis, a nozzle for dispensing the material onto the membrane and a cover for preventing egress of the material from the dispenser until the desired time and also the movement of moisture to the powder mass. It is preferred that the nozzle is coated with an anti-static coating so as to reduce and substantially inhibit the build-up of particulate material in and around the nozzle. Alternative or additionally, the device may incorporate an electro-static elimination arrangement. The particulate material dispenser may further comprise a vibrator and one or more meshes to control the flow of particulate material to the monolayer. The dispenser may comprise two of more meshes whose pore sizes decrease closer towards the monolayer. Any or most vibrations from the vibrator will preferably be insulated from the monolayer. Such insulation may be by a number of means, such as being suspended on springs or resting on foam or other absorbent materials. The vibrator may act upon one or more of the meshes and/or the dispenser itself. The vibrator may be actuated by a number of means, such as mechanical or ultrasonic means.

It is preferred that the dispenser and meshes are removable so that they can be weighed before and after analysing the particulate material so as to assess the total quantity of particulate material which has been dispensed onto the monolayer and that remaining in the dispenser and meshes. Additionally, the dispenser and meshes can be cleaned to remove any residue so as to assess the quantity of residue remaining on it rather than deposited on to the monolayer so that correct calculations of the actual dissolution and/or dispersal of the particles can be made.

The analytical arrangement may also be in-line and capable of analysing the liquid continuously or at pre-determined time points and for example may comprise one or a mixture of: UV spectrophotometer or inverted microscope. The analytical arrangement may alternately (or additionally) be off-line and capable of analysing the liquid at pre-determined time-points and for example may comprise one or a mixture of: UV, HPLC, NMR, Mass Spectrometer or other device used for the assessment of pharmaceutical analysis. Additionally, an imaging device may be provided which views the dispersion of the particulate material onto the monolayer.

The liquid may comprise: water or Gamble's solution, phosphate buffers (including phosphate buffered saline), ultra pure water, sodium chloride, sucrose and sugar based buffers, Artificial lysosomal fluid (ALF), modified Gamble's solution, any other appropriate solutions to accommodate API solubilisation and mixtures thereof.

If desired, the liquid may additionally comprise an additional pharmaceutically important agent, such as a pharmaceutically active ingredient, an adjuvant or excipient so as to enable the analysis of the dissolution and/or distribution of particles relative to another agent which is already present in the liquid.

Preferably, the pH of the liquid is closely controlled and is maintained in the range of 6 to 8. More preferably, the pH is maintained in the range of 6.6 to 7.8. Most preferably, the pH is maintained at approximately 7.0. It will be apparent to the skilled addressee that the pH can be closely controlled by a number of ways (for example simply adding basic or acidic components) during operation of the device or a method using the device.

The volume of the liquid will preferably be approximately 35 ml. However, the volume of the liquid can be varied depending upon the composition and quantity of particles to be dispensed and analysed.

In accordance with a further aspect of the present invention, there is provided a method of analysing dissolution and/or distribution of particles in a pulmonary environment comprising:

(a) dispensing, in a controlled manner, a quantity of particles to be tested to a surfactant monolayer overlaying a reservoir of liquid;

(b) circulating the liquid in the reservoir, whilst substantially maintaining the volume of liquid in the reservoir; and

(c) analysing the liquid for dissolution and/or distribution of the particles within and throughout the liquid continuously and/or periodically.

In order to simulate the pulmonary environment, the method further comprises applying a pre-determined reciprocating lateral force to the monolayer and/or pulsing the circulation of liquid. Furthermore, the particles may be dispensed onto the monolayer in a high humidity environment. Preferably, the humidity is ≧75% relative humidity. More preferably the humidity is ≧80% relative humidity. Most preferably, the humidity is ≧85% relative humidity.

The particles may be dispensed onto the monolayer. In one embodiment, the surface near to the monolayer and/or the liquid is maintained at a substantially constant temperature. Preferably, the temperature is in the range of 32-42° C. More preferably, the temperature is in the range of 35-40° C. Even more preferably, the temperature is in the range of 38-39° C. Most preferably, the temperature is maintained at approximately 37° C.±0.5. The temperature may be controlled by means of a water bath and/or the humidity within the enclosure or the area immediately above the monolayer. Other suitable temperature control arrangements may also be employed.

The particles will preferably be dispensed in a controlled manner by passing them through one or a series of vibrating meshes, such meshes having pore sizes which decrease closer towards the monolayer. This arrangement has been found to enable a controlled deposition onto the monolayer which is similar to particulate matter being inhaled into the deep lung. It is preferred that there are two or more meshes of different pore size. For example, the first mesh may have a pore size the range of 100-125 μm and a second mesh may have a pore size in the range of 40-60 μm. A third mesh may also be provided having a pore size in the range of 150-200 μm. It will be apparent to the skilled addressee that the pore sizes of the meshes will be largely dictated by the particulate material being analysed and that the dispenser could be adapted to interchangeably accommodate a range of meshes of differing pore size.

The dissolution and/or distribution of the particulates analysed may be in-line by passing the liquid through a UV spectrophotometer or unrelated analytical platform (i.e. HPLC) and/or viewed by an inverted microscope arrangement. Alternatively, or additionally, the dissolution and/or distribution of the particulates may be analysed off-line by siphoning a small sample of the liquid and passing this sample through a HPLC.

The liquid may comprise Gamble's solution or any other suitable liquid as outlined above with reference to earlier aspects of the invention

In accordance with a further aspect of the present invention, there is provided a kit of parts for producing a device for analysing dissolution and/or distribution of particles in a pulmonary environment comprising:

(a) a particle dispenser;

(b) a reservoir having upper sides, at least one of which is laterally movable and having an inlet and outlet located beneath the upper sides;

(c) a circulation arrangement adapted to couple to the reservoir via the inlet and outlets so as to enable the liquid contained therein to be circulated; and

(d) at least one analytical arrangement capable of being operably coupled to the reservoir and/or the circulation arrangement for allowing the analysis of the liquid for dissolution and/or distribution of particles.

The kit may further comprise an enclosure for enclosing the reservoir. The kit may further comprise a humidity arrangement for maintaining the humidity around the reservoir. The analytical arrangement may comprise a UV spectrophotometer and/or a microscope.

The kit may of course be used to produce a device or in a method as both herein above described.

The devices and method above can be used for a number of purposes. For example they lend themselves for:
Pre-formulation screening
Dissolution profiling (including hydrophilic or hydrophobic)
Representative and quantitative estimatation of drug particle dissolution
Profiling combination products
Development of engineered particles/polymers/excipients
Quality Control
Branded vs. generic drug analysis
Environmental testing of airborne pollutants

It should be noted that whilst the inventions are described as various aspects, they are interrelated and as such most, if not all features of each aspect, may be applicable to one another even if not strictly stated as such.

### DETAILED DESCRIPTION OF THE INVENTION

Embodiments of the present invention will now be described, by way of example only, with reference to the accompanying figures, in which:

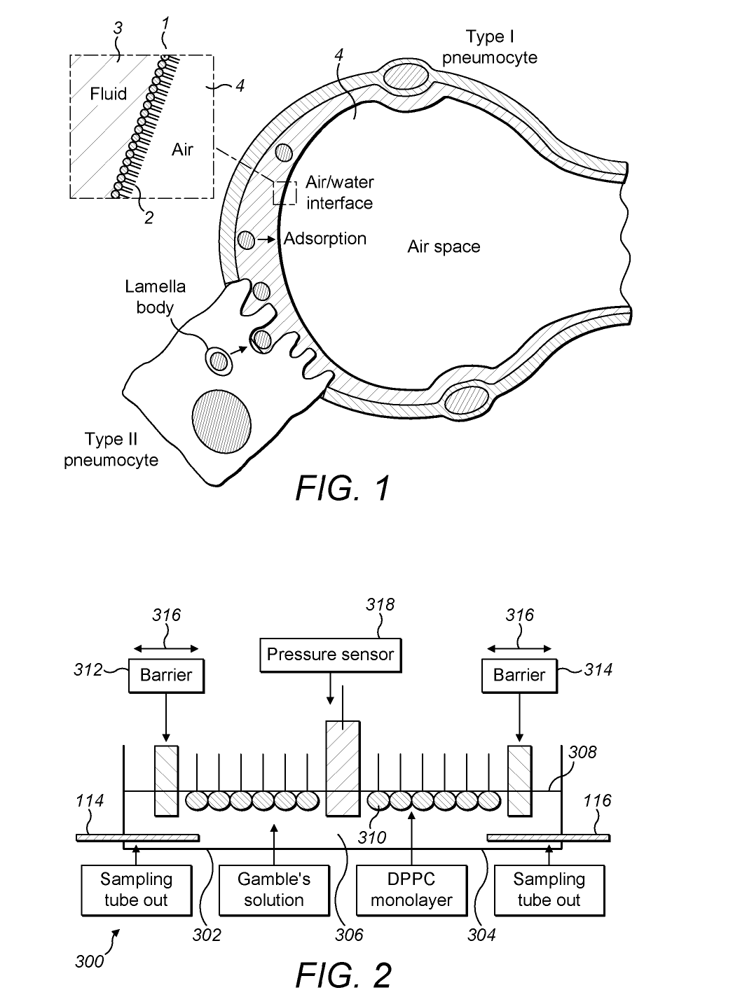

FIG. 1 (PRIOR ART) shows the general arrangement of pulmonary fluid and surfactant molecules found within the deep lung;

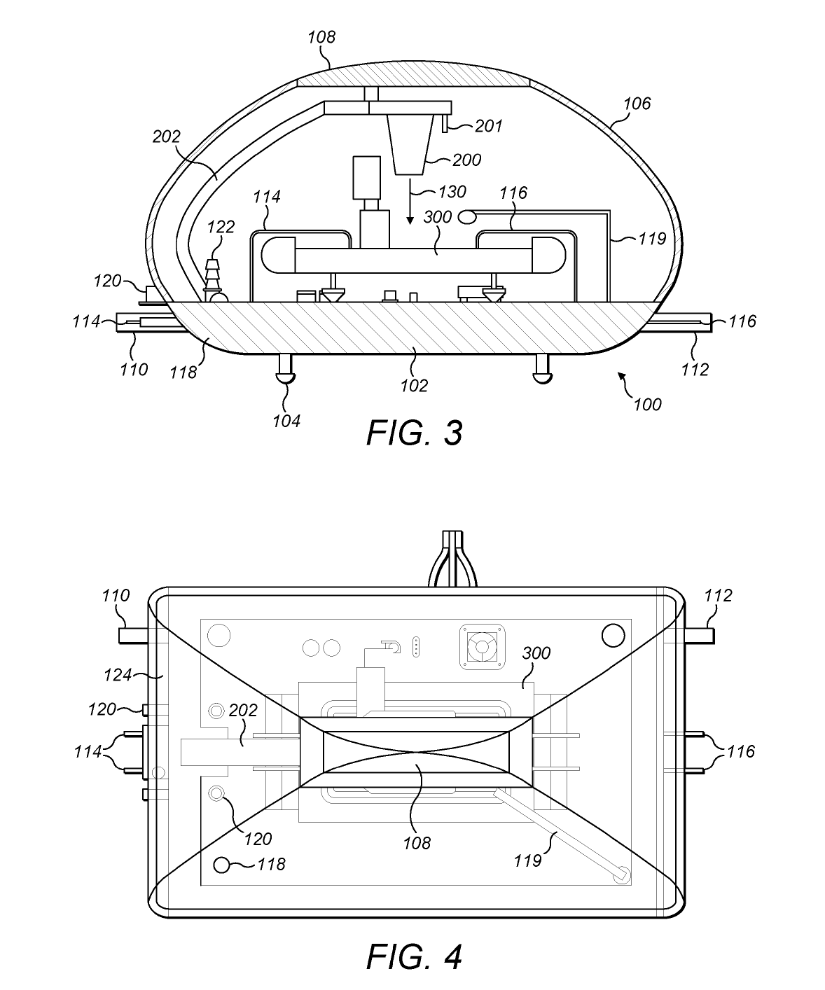

FIG. 2 is a side view of a trough used in the testing device (shown in FIGS. 3 and 4) to mimic molecular organisation at the air-liquid interface;

FIG. 3 is a side view of the testing device of the present invention;

FIG. 4 is a plan view of the testing device as shown in FIG. 3;

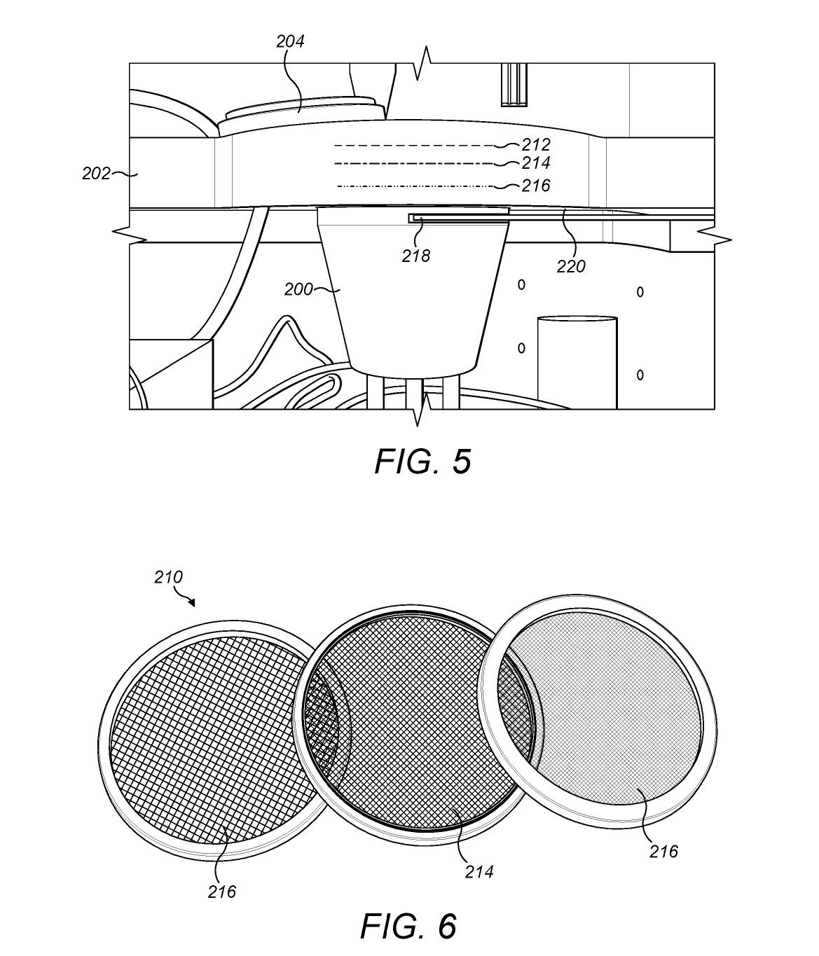

FIG. 5 is a side view of a particle dispenser as used in the testing device;

FIG. 6 shows three mesh inserts for use in combination with the particle dispenser;

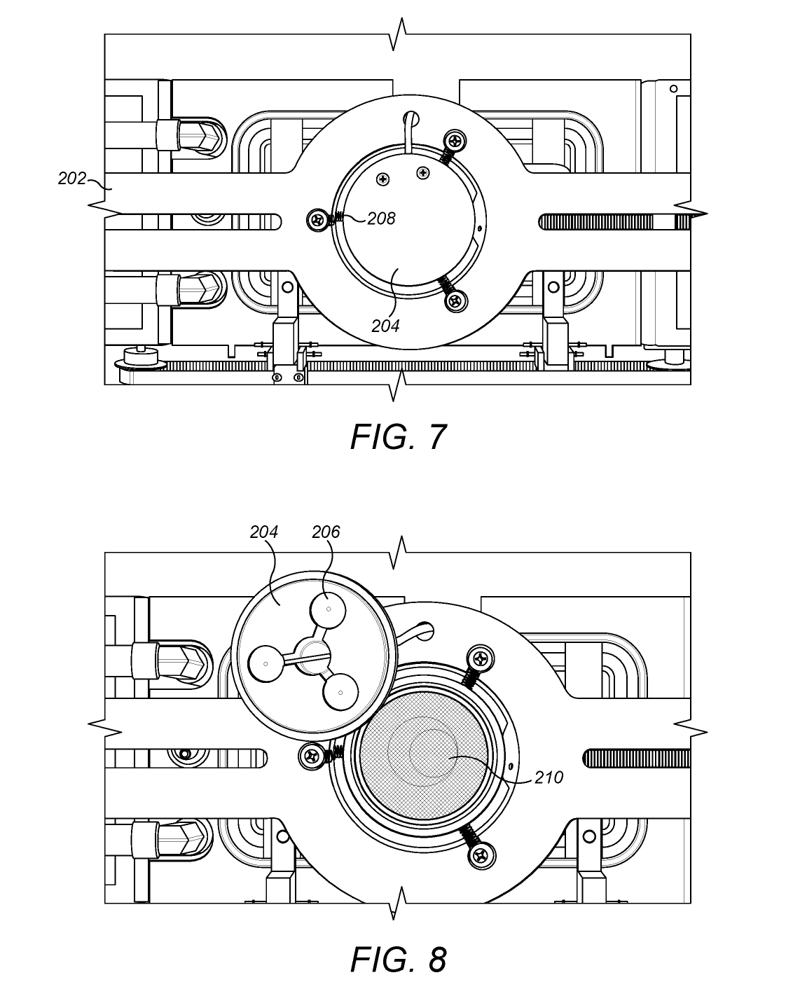

FIG. 7 shows a plan view of the particle dispenser with back plate in place;

FIG. 8 shows a plan view of the particle dispenser with back plate removed;

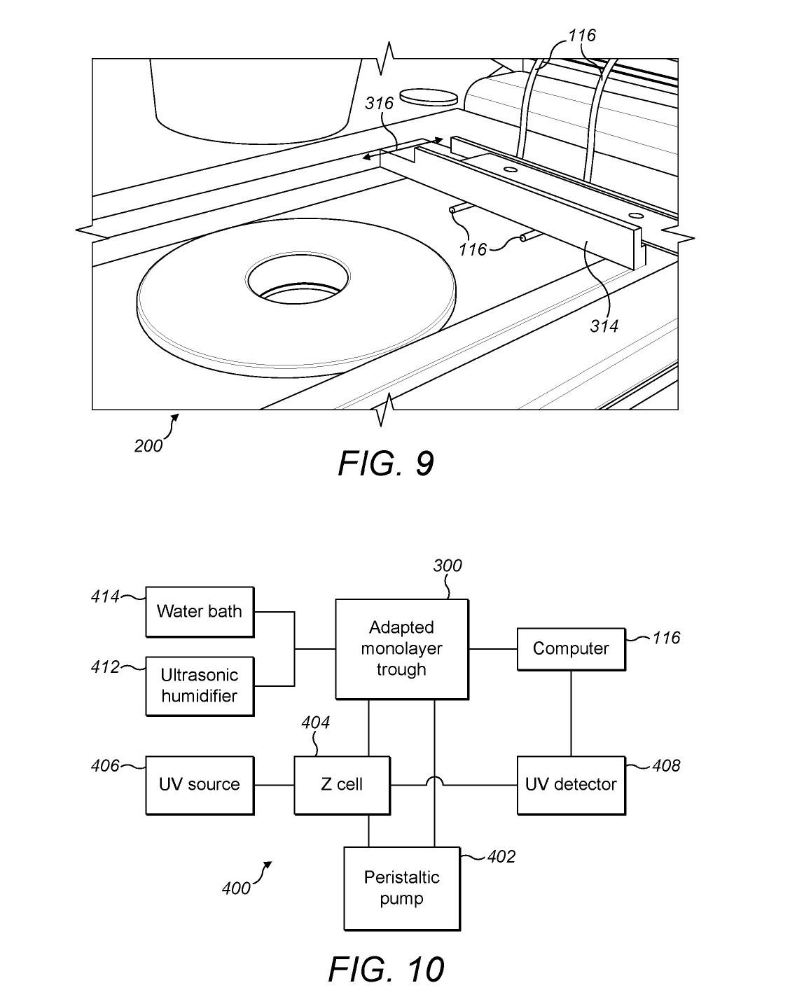

FIG. 9 is a perspective view of part of the trough used in the testing device;

FIG. 10 is a schematic diagram of the various aspects of the testing device and how the aspects interrelate;

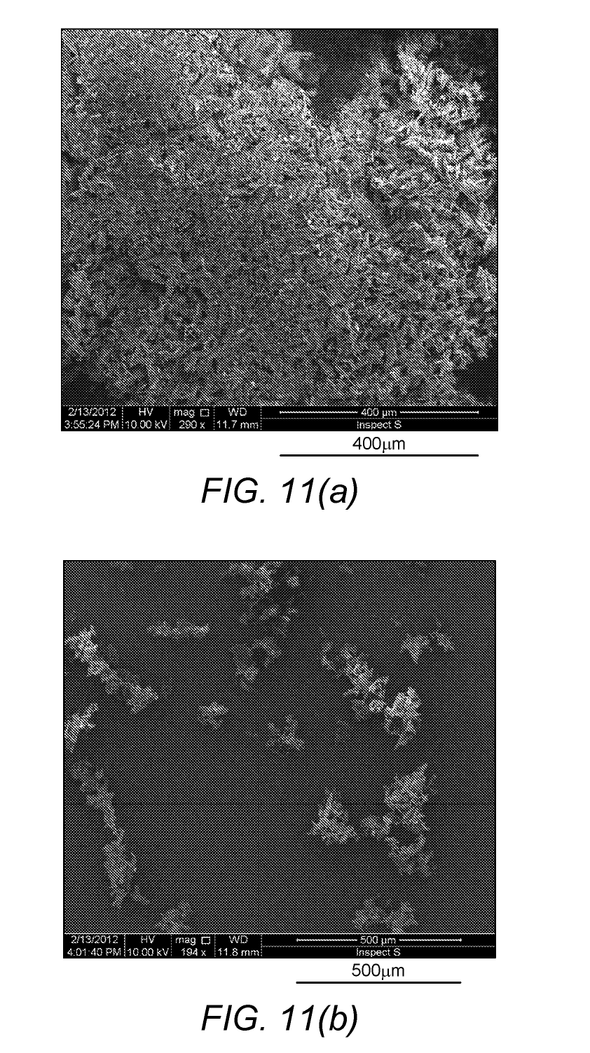

FIG. 11 is a scanning electron microscope (SEM) analysis of a salbutamol sulphate preparation (a) pre- and (b) post-deagglomeration;

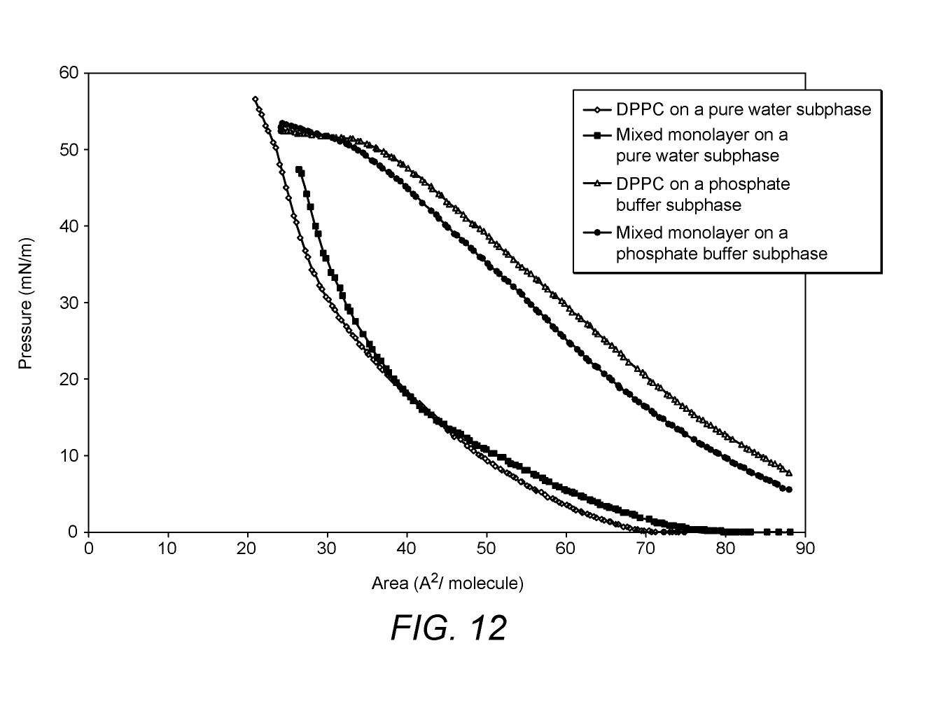

FIG. 12 shows Langmuir isotherms acquired for the various systems described;

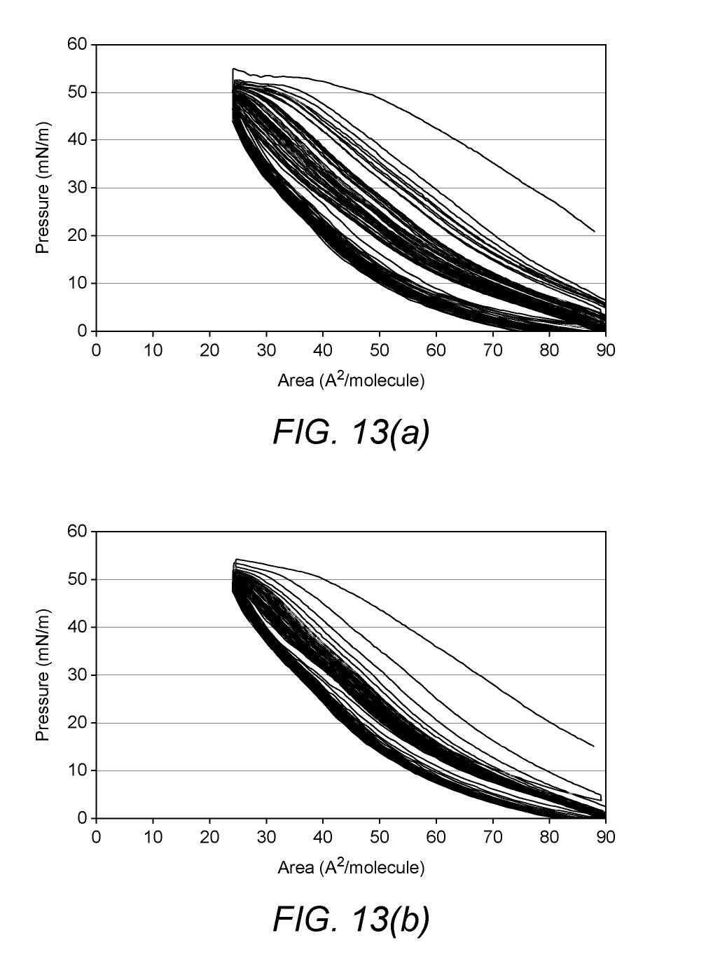

FIG. 13 shows Langmuir isocycles of (a) DPPC and (b) mixed monolayers during inhaled particle delivery and subsequent dissolution;

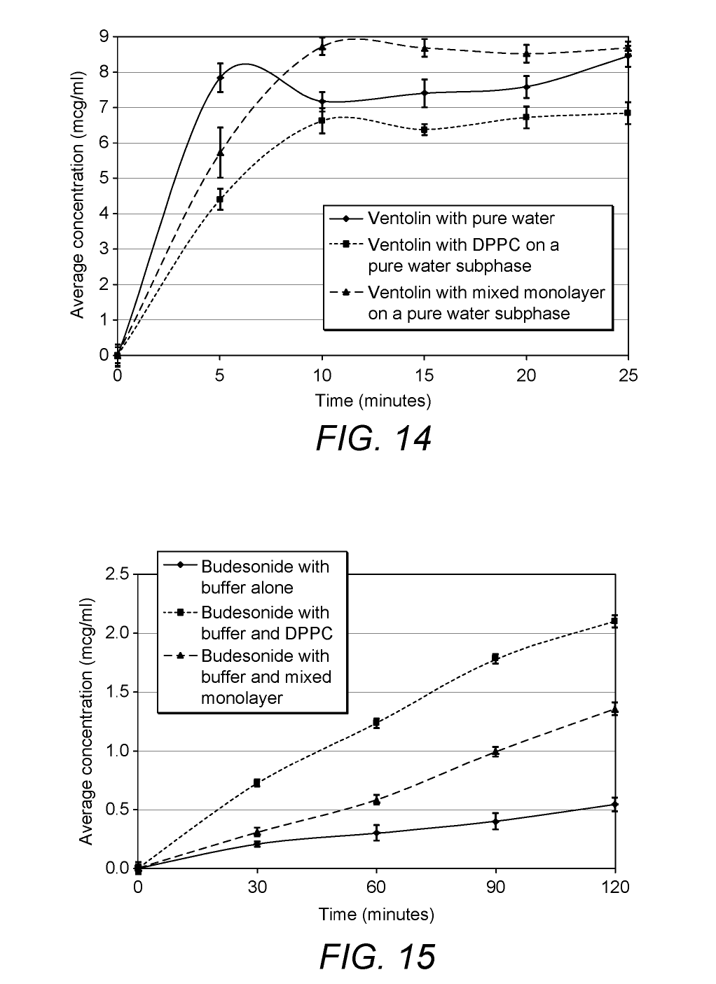

FIG. 14. shows dissolution profiles for (a) water soluble (Ventolin®) and (b) poorly water soluble (Pulmicort®) respirable formulations;

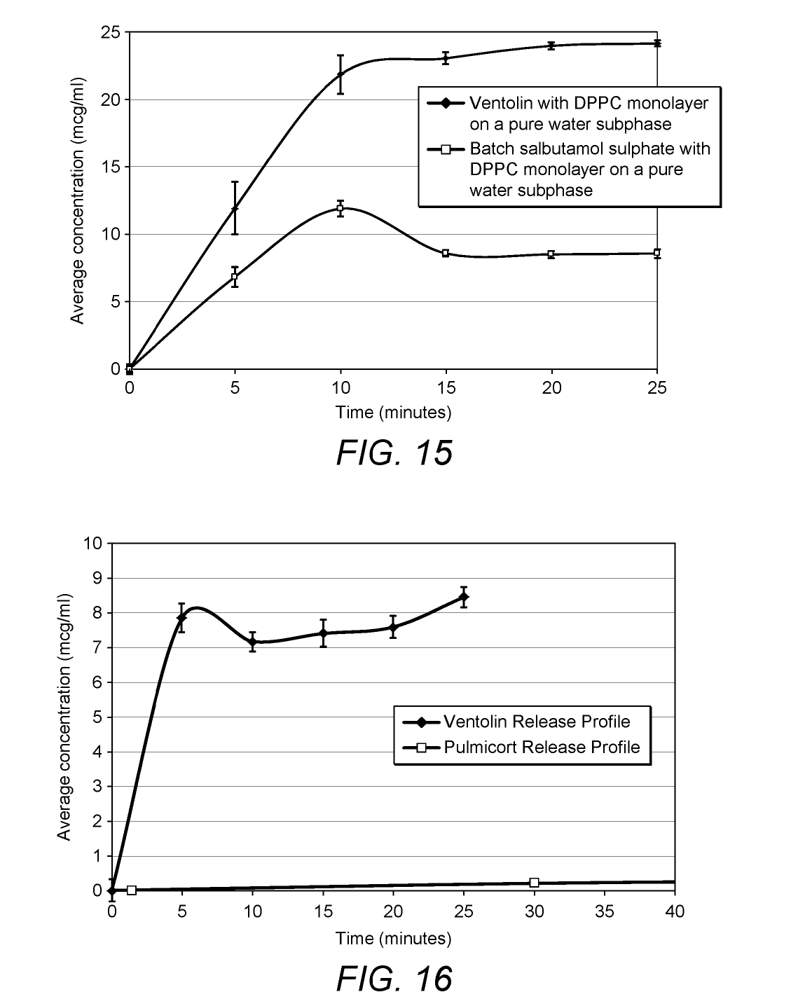

FIG. 15 shows the dissolution profile of two independent salbutamol sulphate powder formulations;

FIG. 16 shows a comparative plot illustrating the ability of the testing device to discern the dissolution profile of two distinct inhaled formulations; and

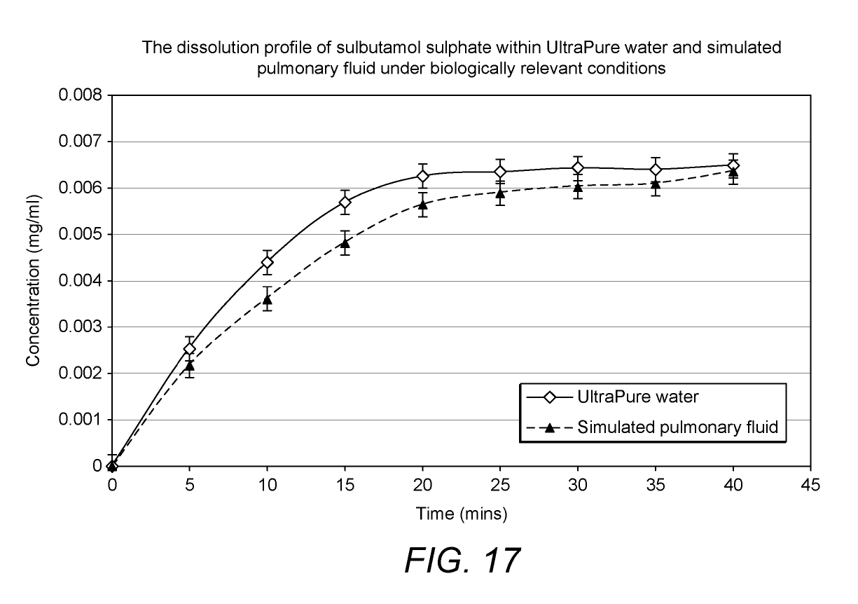

FIG. 17 shows the dissolution profile of salbutamol sulphate within a buffer system and simulated pulmonary fluid under biologically relevant conditions.

The arrangement of pulmonary fluid and surfactant molecules within the deep lung is illustrated in FIG. 1. As shown, the amphiphilic molecules 1 are arranged with their hydrophilic moieties 2 in contact with the fluid phase 3 and position their hydrophobic groups towards the lumen 4 of the alveolar space; ultimately forming a stable monomolecular layer. A range of fluids (i.e. pure water, Gamble's solution or buffer systems) may be used within the laboratory setting to represent the fluid phase 3.

FIGS. 3 and 4 show a device for simulating and studying pulmonary environment which can be used for a number of purposes (as will be described later). FIG. 3 shows a side view of a testing device 100 which incorporates an modified Langmuir monolayer trough 300 which is shown in greater detail in FIG. 2. The testing device 100, has a flat base 102 with adjustable legs 104 extending downwardly. On an upper surface of the base 102, rests a transparent hood 106 with a handle 108 located on its upper most surface so as to enable a user to lift the hood 106 on and off the base 102. A rubber seal (not shown) extends around the edge of the hood 106 so as to ensure the hood provides a sealed environment when placed on the base 102. From the sides of the base 102, extend a humidity in-pipe 110 and a humidity out-pipe 112 which enable the interior of the testing device 100 to have its interior humidity controlled via an external humidity device (not shown). In the centre of the base 102 rests the monolayer trough 300 which has two parallel sample-in pipes 114 on the left hand side of the trough and two parallel sample-out pipes 116 located to the right hand side of the trough. Directly above the monolayer trough 300, is a particle dispensing nozzle 200 which extends from an arcuate arm 202 extending from one side of the base 102. A humidity probe 119 extends from the base 102 to an area just above the trough 300 so that the humidity can be closely monitored and adjusted if required. A base level 118 is also provided on the upper surface of the base 102 in order to assist a user in adjusting the legs 104 such that the upper surface of the base 102 lies completely flat. A small control panel 120 extends to the rear of the base 102. A heating-in conduit 122 and a heating-out pipe 124 extends from the upper surface of the base 102 in order to allow the device to receive water heated to 37° C. If additionally required, the device may incorporate or be utilised in conjunction with an ‘air table’ so as to minimise any external vibrations.

With reference to FIG. 2, there is shown an adapted Langmuir monolayer which is used to simulate the pulmonary environment. The monolayer trough 300 comprises a rectangular vessel 302 which has towards its base 304 sample-in tubes 116 and the sample-out tube 114. The vessel 302 is filled with subphase of Gamble's solution 306 and along the meniscus 308 of the Gamble's subphase solution 308 is a surfactant DPPC monolayer 310 extending between a left hand side and right hand side barrier 312, 314 which can reciprocally move from side to side in the direction denoted 316. In the alternative, the subphase may comprise any alternative dissolution buffer such as any aqueous based media including:

ultrapure water; phosphate buffered saline (PBS); NaCl; a sucrose based solution and mixtures thereof. In place of the DPPC monolayer could be any commercially available products (i.e. Survanta and Curosurf) or more basic surfactant types (POPG or PA) and any combinations thereof. A pressure sensor 318 is provided in the middle of the vessel 302 in order to allow measurement of the pressure under which the DPPC monolayer (any commercially available surfactant preparation or components thereof may be used) 306 is placed due to the reciprocating movement of the left hand and right hand side barrier 312, 314. The barriers shown in this example are ‘fixed’ barriers, however, more flexible ribbon barriers would work equally well.

Referring now to FIGS. 5-8, the particle dispensing nozzle 200 is shown in greater detail. The nozzle 200 has an anti-static coating and is shown to extend from the arm 202 and an electro-static elimination arrangement 201 is located near to the arm 202 to further reduce the likelihood of charged particulate matter being attracted to the immediate surfaces of nozzle. The nozzle 200 incorporates a back plate 204 which incorporates vibration modules 206 intended to enable the nozzle 200 to be vibrated when desired. In an alternative arrangement (not shown), one or more vibration module are adapted to vibrate one or more of the meshes rather than the nozzle itself. The nozzle itself is suspended from the arm 202 by means of spring members 208 intended to prevent the transfer of any vibration from the vibrating modules 206 to the arm 202 and ultimately to the base 102 of the device, thus preventing disruption of the surfactant monolayer during the dissolution protocol. When the back plate 204 is removed, a number of mesh inserts 210 can be inserted. FIG. 8 shows a mesh insert in place, but up to three mesh inserts 210 can be inserted into the nozzle if desired. In FIG. 5, a large pore size mesh 212 is placed in a position upper most within the nozzle, a medium pore sized mesh 214 is placed in a middle position (indicated in FIG. 5) and a small pore size mesh 216 is placed in a lower part of the nozzle 200 an aperture 218 is able to receive a cover 220 in order that the particulate material and mesh inserts 210 are protected from the humidity found inside the device during operation. In an alternative embodiment, different meshes are matched with particle sizes and only one mesh is used in the dispensing nozzle 200.

With reference to FIG. 9, a perspective view of part of the monolayer trough (Nima Technology 102M) 300 is shown and it can be clearly seen that the parallel sample-in tubes 116 extend under the reciprocating barrier 314 (reciprocating in direction) when in use. With reference to FIG. 10, there is shown a schematic diagram illustrating the various components of the system used in order to simulate the pulmonary environment which are connected to the testing device 100. The monolayer trough 300 is supplied by a peristaltic pump (VVatson Marlow 120S) 402 which pumps the Gamble's solution 306 through the trough vessel 302 and through a “Z” cell (Ocean Optics) 404. A UV source (Ocean Optics D2000 Deuterium Mikropack) 406 is connected to the Z cell 404 and results obtained by means of the UV detector (Ocean Optics HR4000CG-UV-NIR) 408 which is also connected to the Z cell. The UV detector is connected to a computer 410 which also controls most, if not all, of the motorised and automatic systems of the device. An ultra-sonic humidifier (Honeywell Ultrastar BH860E) 412 is connected to the humidity in and out pipes 110, 112 and a water bath (ThermoHaake DC30) 414 is also connected to the device so as to provide and allow for the Gamble's solution to be heated and maintained at the desired temperature.

In use, the handle 108 of the transparent hood 106 would be used in order to remove the hood from the base 102. The base level 118 would be used in order to allow the user to adjust the adjustable legs 104 so that the base 102 lies completely flat before experiments are conducted. The humidity in and out pipes 110, 112 would be connected to the ultra-sonic humidifier 412. The sample in and out pipes 114, 116 will be connected to the peristaltic pump 402 via the Z cell 404. The Z cell 404 will also be connected to the UV source and UV detector 408 which in turn would be connected to the computer 410. The water bath 414 would be connected to the heat in and out pipes 122 so as to provide heat to the device. The monolayer trough 300 would be set as shown in FIG. 2, whereby the vessel 302 would be filled with Gamble's solution 306 with a DPPC monolayer resting on or around the meniscus 308 of the Gamble's solution. The particle dispenser cover 220 would be inserted into the aperture 218 of the nozzle 200 and the mesh's 212, 214, 216 placed in the inner part of the nozzle 200 on top of the upper most mesh 212, will be placed the particulate material to be tested and the cover plate 204 placed on top of the nozzle.

The hood 106 would then be placed on top of the base 102 and the computer 410 set to experimental parameters as desired. If required, an opaque shroud (not shown) may be placed over the hood 106 so as to closely replicate the dark environment of the deep lung (and remove any photon interaction with the particles. When the Gamble's solution 306 is at the correct temperature and the interior of the device has attained the correct humidity and temperature for the experiment, the user will activate the external control panel/computer to vibrate the nozzle 200 via the vibrating modules 206 and arcuate removal of the cover plate 220 will be removed from the aperture 218 so as to allow the particulate material to be dispensed out of the nozzle 200 in direction 130 onto the DPPC monolayer 306. Barrier 314 continues to move in a reciprocal direction 316 thus exerting pressure on the monolayer 306 and simulating the interior of the lung as it expands and contracts and affect the membrane permeability. The Gamble's solution 316 is continually circulated through the vessel 302 through the peristaltic pump 402 and via the Z cell 404. The flow speed of the peristaltic pump 402 can be varied if desired so as to increase or decrease the circulation flow of the solution. Particulate content or solubility of any components within the particulate material is detected via the UV detector 408 and fed back to the computer 410 for later analyses.

After experimentation, the dispenser nozzle and meshes are removed and washed down and any particulate material (whether in solid or solution) in the wash solution is assessed and any calculations of particle content or solubility within the Gamble's solution is corrected accordingly.

Modifications can of course be made to the device 100 which would still result in a device accurately simulating the pulmonary environment of a human body. For example, an aperture may be provided in the centre of the 106 which would enable a user to simply spray the particulate material directly onto the monolayer trough 300 other devices used for detecting changes in the dissolution media could be employed, for example the trough vessel 302 could be transparent and placed underneath so as to the allow for microscopic analyses of the particle dispersion or solution.

The experiments now described highlights the potential which the testing device 100 holds to monitor the dissolution profile of inhaled formulations. The device relies on the integration of an adapted Langmuir trough 300, an ultra-violet (UV) spectrophotometer 408 along with a dedicated drug delivery/environmental control unit. As a whole, the system (hereinafter referred to as the ‘Inhaled Drug Particle Dissolution Device’ (IDPDD)) provides a unique route to probe drug release from inhaled particles within an environment representative of the deep lung. The crucial theme underscoring these experiments is the accurate depiction of the in vivo scenario. To this end, the IDPDD incorporates a means by which to disperse a dry powder formulation of interest (with scope to modify the approach for solution-based products), facilitate delivery and subsequent interaction of respirable particles with simulated surfactant monolayers 306; thus allowing for drug particle dissolution within media representative of that found within the lung. Importantly, the protocol incorporates repeated surfactant monolayer expansion-contraction cycles and offers the user control over temperature and humidity, in order to maximise complementarity with the lung. Dissolution takes place under repeated expansion-contraction cycles sufficient in number for experiment completion—this could be 30 or 100 dependant on the particle being analysed.

An adapted Langmuir trough 300 was used to mimic the arrangement of pulmonary fluid and surfactant molecules within the laboratory. The overall arrangement is shown in FIG. 2 and outlined above. Note the sampling tubes 114, 116 located beneath the surfactant monolayer (which would be beneath the barrier 314 height).

The IDPDD relies upon the integration of distinct pieces of equipment and the arrangement of the unit is outlined in FIG. 10. The IDPDD is primarily composed of an adapted Langmuir trough 300, a UV spectrophotometer 408 and a drug delivery device/environmental control chamber. As a function of the design, scope exists to achieve a temperature of 37° C. within the dissolution media (i.e. supporting hypophase and surfactant monolayer) and elevated relative humidity (i.e. 80% RH+) within the immediate environment as noted within the respiratory system.

### Scanning Electron Microscopy Analysis of a Salbutamol Sulphate Preparation

The morphology of a raw salbutamol sulphate sample obtained from Bufa Pharmaceuticals was investigated by scanning electron microscopy (SEM). SEM images of a salbutamol sample at (a) ×290 (pre-deagglomeration) and (b) ×194 (post deagglomeration) are presented in FIGS. 11a and 11b, respectively.

The images confirm that the raw salbutamol sulphate sample is composed of small particles forming large agglomerates; typical of dry powder formulations. The agglomerates develop due to cohesive interactions between individual drug particles. During the course of drug delivery to the lung particle masses, such as those featured in FIG. 4a, must deagglomerate to achieve effective pulmonary deposition.

### Mesh Inserts to Achieve Powder Deagglomeration

With respect to the IDPDD, a powder deagglomeration step is included prior to delivery of drug particles to the surfactant monolayer and supporting fluid. In order to achieve powder deagglomeration a series of mesh inserts 210 have been fabricated, ranging from 50 μm to 800 μm; as shown in FIG. 6. The inserts may be interchanged at the outset of a particular study such that the experiment may be tailored to the formulation under investigation.

### Langmuir Monolayer Isotherms

Typical Langmuir isotherms for DPPC and the mixed monolayer system supported on a pure water subphase are shown in FIG. 12. The apparent difference in the plots, when in contact with a phosphate buffer subphase, may be ascribed to the interaction with phosphate anions, resulting in expanded Langmuir monolayers.

### Langmuir Monolayer Isocycles

Langmuir isocycles (i.e. repeated expansion-contraction cycles) were performed to both simulate inhalation-exhalation cycles within the lung and monitor the response of the DPPC and mixed monolayers to the delivery of the drug substance and subsequent dissolution; accepted traces are shown in FIG. 13. The data confirm that the delivery of drug particles and related dissolution did not adversely affect the monolayer and thus confirm structural integrity throughout the study.

### Dissolution Profiles of Water Soluble and Poorly Water Soluble Respirable Drug Formulations

Dissolution data relating to salbutamol sulphate (i.e. Ventolin®) and budesonide (i.e. Pulmicort®) are presented in FIG. 14. The data confirmed the suitability of the IDPDD to monitor drug release from inhaled formulations consisting of either water soluble or poorly water soluble APIs, under conditions representative of the deep lung (NB: 37° C. and 80% RH). Here, it is apparent that the concentration of drug substance increased with respect to time. Wth regards to the Ventolin® preparation, release rate was maximal in the case of a pure water subphase and retardation of this parameter was evident on addition of DPPC or mixed surfactant monolayers. Statistical significance was highlighted in each case via ANOVA calculations (p=0.000). In terms of the Pulmicort® product, the release rate of the therapeutic agent was minimal with the phosphate buffer system alone and this term was enhanced with the addition of amphiphilic material, as per that noted in the deep lung. Once again, statistical significance was evident for each system under investigation (p=0.000). Clearly, the experimental arrangement has an impact on release mechanics from inhaled formulations.

### Dissolution Profiles of Different Water Soluble Drug Preparations

The data presented in FIG. 15 demonstrate the ability of the IDPDD to discern the drug release profile of two independent products containing the same drug substance. The apparent variability in release rates may be attributed to the size of the drug particles for each product. Note: the difference evident in the final concentration relates to the loss of material on delivery to the monolayer surface. However, with this point in mind, data are available quantitatively establish the rate of release from this product.

### The Differentiation between Release Rates of Commercially Available Respirable Preparations

The IDPDD may be employed to distinguish the release rates of different respirable preparations, as outlined in FIG. 16. The results may be employed to rationalise dosing strategies. For example in this case, Ventolin® is prescribed for frequent administration during the day (e.g. up to 4 times each day) to rapidly tackle airways obstruction. However, Pulmicort® is administered relatively infrequently (e.g. typically twice each day) to work in the background by reducing airways inflammation and it may be argued from the dissolution data presented here that this product has an inherent ‘modified release’ quality.

### Dissolution Profile of an Active Ingredient Within Ultrapure Water and Simulated Pulmonary Fluid

The data shown in FIG. 17 demonstrates the dissolution behaviour of water soluble respirable drug particles under a simulated pulmonary environment; namely a temperature of 37° C., elevated humidity (80% RH) and fluid hydrodynamics as per the deep lung. The results confirm that the concentration of the drug substance increases with respect to time, ultimately reaching a steady state position. The difference in the plots may be ascribed to the environment under which dissolution is taking place. The plot involving ultrapure water indicates a sharp increase in drug concentration during the early phase, finally reaching a constant concentration. However, in the case of the simulated pulmonary fluid whilst a similar trend is evident retardation in drug release is demonstrated and this suggests that the media has an impact upon release mechanics (i.e. it forms a natural barrier to drug release). The variation in the plots is of significance. The data indicate that the approach taken and dissolution media are important considerations in the assessment of inhaled drug particle dissolution. The approach taken here lends itself well to the execution of statistical analysis to test for significance between the data (i.e. the pure water system and simulated pulmonary surfactant system), whilst at the same time providing the end-user with scope to mathematically model drug release kinetics to ultimately allow for predictions in formulation behaviour under in vivo conditions.

### SUMMARY

The proof of principle work outlined above supports that the IDPDD provides both a reliable and reproducible method by which to probe drug release from inhaled formulations, whilst at the same time being pharmaceutically and biologically relevant. The underlying objective was to mimic, as closely as possible, the in vivo scenario. To this end, the approach involves four stages: (1) powder deagglomeration, (2) delivery of a drug sample to a simulated surfactant monolayer, (3) particle interaction with that monolayer and (4) drug release as anticipated in the deep lung. The data presented here confirms the suitability of the IDPDD to assess the dissolution profile of inhaled drug particles in a pulmonary environment. In each case the results demonstrate a trend for increasing drug concentration within solution with respect to time.

Potential exists for the IDPDD to be applied as a pre-formulation screening tool within the industrial setting to examine the drug release profile from a powder sample prior to scale up, thus providing opportunity to streamline product development and reduce overall expenditure. In relation to this, interest has recently been stimulated in developing engineered particles (i.e. modified release particles) to optimise therapeutic outcomes. Here, the IDPDD could be used to screen for formulation suitability and allow for direct comparisons with existing preparations. Moreover, the approach may be applied to for quality control purposes (i.e. to monitor batch-to-batch variability). Should large fluctuations in the release profile of a particular formulation arise, the batch may be modified to reduce the inherent variability. Furthermore, the IDPDD may be used to conduct in vitro-in vivo correlation (IVIVC) studies to support new drug applications.

The key advantages of our technology platform is that it closely mimics the lung environment and will enable the investigation of drug interactions by controlling a number of parameters dependent on specific requirements.

The device and methods will assist in the drug formulation process, inform modifications such as dosing levels and frequencies, improving drug efficacy, and in turn therapeutic outcomes. The technology platform will also inform upon the crystallisation behaviour and physiochemical characterisation of active pharmaceutical ingredients (APIs) for delivery to the lung.

It will be apparent to the skilled addressee that the device is adaptable so as to permit the modification of a number of variables so as to enable it to be used for testing a wide range of particulate and environmental material. For example, the lung fluid composition, temperature, light, humidity, pH, volume, hydrodynamics of monolayer movement can all be modified so as to mimic different lung conditions (for example diseased lungs).

The forgoing embodiments are not intended to limit the scope of the protection afforded by the claims, but rather to describe examples of how the invention may be put into practice.

1. A device for simulating and studying the absorption of a sample in a pulmonary environment comprising:
(a) a surfactant monolayer located within a barrier, wherein at least part of the barrier is movable so as to enable a force to be applied to the monolayer;
(b) a reservoir of liquid disposed underneath the monolayer;
(c) a dispenser for dispensing a sample on to the monolayer; and
(d) a circulation arrangement adapted to circulate the liquid in the reservoir underneath the monolayer.

2. The device as claimed in claim 1, wherein the device further comprises:
(e) an analytical arrangement capable of analyzing the liquid.

3. The device of claim 1, wherein the sample comprises a particulate and/or gaseous material.

4. The device of claim 1, wherein at least part of the barrier is movable along a lateral axis so as to provide a lateral force on the monolayer.

5. The device of claim 2, wherein the analytical arrangement is capable of analyzing the liquid passing through the circulation arrangement and/or under the monolayer.

6. The device of claim 1, wherein the barrier is capable of applying a cyclical reciprocating force to the monolayer.

7. A method of simulating and studying the absorption of a sample in a pulmonary environment comprising:
(a) providing a reservoir of liquid overlaid with a surfactant monolayer;
(b) applying a cyclical lateral force to the monolayer;
(c) circulating the liquid in the reservoir underneath the monolayer;
(d) contacting the sample with the monolayer; and
(e) analyzing the liquid for a presence and/or a quantity of the sample, or component thereof, in the liquid after a pre-determined incubation time.

8. The method of claim 7, wherein the liquid is circulating continuously or cyclically whilst substantially maintaining the same volume of liquid in the reservoir.

9. A device for analyzing dissolution and/or distribution of particles in a pulmonary environment comprising:
(a) a particulate material dispenser;
(b) a surfactant monolayer overlaying a reservoir of liquid;
(c) a circulation arrangement adapted to circulate the liquid in the reservoir; and
(d) an analytical arrangement capable of analyzing the liquid, wherein the particle dispenser is located above the monolayer so as to enable particulate material to be dispensed onto the monolayer and the analytical arrangement allows the distribution and/or dissolution of the particulate material within and throughout the liquid to be assessed continuously and/or periodically.

10. The device of claim 9, wherein the device further comprises a barrier around the monolayer which can apply a pre-determined lateral force to the monolayer.

11. The device of claim 10, wherein at least part of the barrier is reciprocally movable along a lateral axis.

12. The device of claim 9, wherein the circulation arrangement is adapted to circulate the liquid continuously and/or cyclically whilst substantially maintaining the same volume of liquid in the reservoir.

13. The device of claim 9, wherein the device further comprises an enclosure for enclosing the dispenser and monolayer and wherein the device further comprises a humidifier for producing and/or controlling the humidity within the enclosure.

14-19. (canceled)

20. The device of claim 9, wherein the analytical arrangement is:
a) in-line and capable of analyzing the liquid continuously or at pre-determined time points; or
b) off-line and capable of analyzing the liquid at pre-determined time-points.

21. (canceled)

22. The device of claim 9, wherein the analytical arrangement comprises one or a mixture of: a UV spectrophotometer, an inverted microscope, an HPLC, an NMR and a Mass Spectrometer.

23. (canceled)

24. (canceled)

25. A method of analyzing dissolution and/or distribution of particles in a pulmonary environment comprising:
(a) dispensing, in a controlled manner, a quantity of particles to be tested to a surfactant monolayer overlaying a reservoir of liquid;
(b) circulating the liquid in the reservoir, whilst substantially maintaining the volume of liquid in the reservoir; and
(c) analyzing the liquid for dissolution and/or distribution of the particles within and throughout the liquid continuously and/or periodically.

26. The method of claim 25, wherein the method further comprises applying a pre-determined reciprocating lateral force to the monolayer and/or pulsing the circulation of liquid.

27. The method of claim 25, wherein the particles are dispensed onto the monolayer in a high humidity environment.

28. (canceled)

29. The method of claim 25, wherein the particles are dispensed onto the monolayer, and the liquid maintained, at a substantially constant temperature.

30. The method of claim 29, wherein the substantially constant temperature is in the range of 32-42° C.

31. The method of claim 25, wherein particles are dispensed in a controlled manner by passing them through a series of vibrating meshes, the meshes having pore sizes which decrease closer towards the monolayer.

32. The method of claim 25, wherein the dissolution and/or distribution of the particulates is analyzed:
a) in-line by passing the liquid through a UV spectrophotometer and/or microscope. or
b) off-line by siphoning asmall and passing m le through an HPLC.

33-39. (canceled)

40. The device of in claim 1, wherein the circulation arrangement is adapted to circulate the liquid continuously and/or cyclically whilst substantially maintaining the same volume of liquid in the reservoir.

41. The device of claim 1, wherein the device further comprises an enclosure for enclosing the dispenser and monolayer and a humidifier for producing and/or controlling the humidity within the enclosure.

42. The device of claim 2, wherein the analytical arrangement is:
a) in-line and capable of analyzing the liquid continuously or at pre-determined time points; or
b) off-line and capable of analyzing the liquid at pre-determined time-points.

43. The device of claim 2, wherein the analytical arrangement comprises one or more of: a UV spectrophotometer, an inverted microscope, an HPLC, an NMR, and a Mass Spectrometer.
